(19) United States
(12) Patent Application Publication
(10) Pub. No.: US 2007/0256775 A1
(43) Pub. Date: Nov. 8, 2007

(54) Parquet adhesive and method for avoiding or reducing the evaporation of organic solvents included in adhesives

(75) Inventors: Goetz Hillert, Pirmasens (DE); Martin Schaefer, Godramstein (DE); Juergen Fritz, Hoeheinoed (DE)

Correspondence Address: Orum & Roth LLC, 53 W Jackson Blvd. #1616, Chicago, IL, 60604, US

(73) Assignee: Wakol GmbH

(21) Appl. No.: 11/800,281

(22) Filed: May 4, 2007

(30) Foreign Application Priority Data
May 5, 2006 (DE) 102006021325.4

(51) Int. Cl. B32B 37/12; E04F 13/00

(52) U.S. Cl. 156/71; 156/327; 156/326

(57) ABSTRACT

In the current invention, a paraffin or waxy substance is added to a solvent-based parquet adhesive to generate a contiguous film that forms a barrier layer between the adhesive and the surrounding air. This barrier prevents volatile solvents from escaping and contaminating the surrounding air before parquet laying. The protective film can then be destroyed by laying down the parquet strips on the substrate. This process overcomes disadvantages to using state of the art solvent-based adhesives which are susceptible to undesirable swelling of parquet wood and contamination of air.

For bonding parquet and other floor, wall and ceiling coverings to substrates, liquid or slightly pasty adhesives are applied to the substrate and distributed on the substrate. For floor covering adhesive applications, the adhesives must have a certain shear strength. The shear strength of adhesives describes the ability of an adhesive to resist the lateral shear force which is acting upon an adhesive. Shear strength is particularly required in parquet adhesives, in order to prevent movement of bonded parquet strips through shrinkage or swelling action as the wood moisture changes.

Frequently, polyurethane-based reaction resins are used. However, the disadvantage of such two-component polyurethane systems is that they only have a limited pot life and that the monomeric isocyanates have a sensitizing and allergenic potential. In addition, reaction resin parquet adhesives require extensive occupational safety procedures, are relatively high in price, must be used in exactly defined mixing ratios, and are thus difficult to process. From the standpoint of occupational hygiene they are thus less suitable than water-based dispersion adhesives, cement-containing powder adhesives, and solvent-based synthetic resin adhesives. Compared to aqueous dispersion resins and powder adhesives, however, solvent-based synthetic resin adhesives have the technical advantage in that they do not draw water into the laid covering or parquet, which in turn largely prevents swelling pressure and subsequent shrinkage loss due to drying, particularly in the case of wood. This remains one of the reasons why solvent-based synthetic resin adhesives continue to be the material of choice for these types of applications and why their market share in the parquet sector is between 65 and 70%.

The solvent-based synthetic resin adhesives which are presently on the market consist of polymers, resins (mostly polyvinyl acetate), fillers (e.g. chalk), additives and solvents. The solvent content is typically between approximately 16 and 25% w/w. Solvents being used are primarily aliphatic esters (e.g. methyl acetate or ethyl acetate), aliphatic alcohols (e.g. methanol, ethanol or isopropanol) and aliphatic ketones (such as acetone or methyl ethyl ketone).

In order to be compliant with allowable airborne threshold limit values for solvents in the workspace when using such adhesives, an effort is being made to use as little solvent as possible right from the outset, and to use nontoxic solvents with airborne threshold limit values that are as high as possible. This permits, for example, a solvent mixture of acetone and ethanol to be used. Under suitable processing conditions, using little solvent, it is possible to comply with these airborne threshold limit values without problems; however, the disadvantage of this approach is that the reduction in the amount of solvent causes a disproportionately strong increase in the viscosity of the adhesive mixture, which in turn compromises processing properties such as brushability. This disadvantage can be countered by using polymers and resins with a lower molecular weight and resulting lower solution viscosity. However, this in turn results in an undesirable reduction of the mechanical strength properties after curing.

In order to comply with occupational exposure limit values (OEL), protic polar solvents such as alcohols (in particular the ethanol used here) are frequently used in solvent-based parquet adhesives, as described previously. This leads yet to another disadvantage. Similar to water, protic polar solvents cause swelling pressure in wood, which leads to the initial swelling of the wood and subsequent shrinking during evaporation of the solvent. This leads to unwanted deformation or gap formation in the parquet floor.

Moreover, the solvent-based parquet adhesives now in use have the following additional disadvantage: due to solvent evaporation after application of the adhesive, parquet strip laying time is limited. Due to the evaporation of the solvent, the viscosity of the applied adhesive greatly increases, and, depending on the system used as well as the temperature and ventilation conditions, the adhesive becomes after 10 to 20 minutes so pasty that it can no longer be transferred onto the wood to be bonded. In practice, the parquet layer can determine this by laying the parquet strip onto the applied adhesive bed, briefly applying pressure to the strip, then picking up the strip again and assessing the degree of wetting on the back of the parquet strip. Depending on the type of parquet, the wetted surface area on the back of the parquet strip must be at least 40 to 70%. When performing demanding laying work, such as laying herringbone patterns or in corners and crevices, or below heaters, that requires individual strips to be accurately trimmed to size, a maximum laying time of 10 to 20 minutes is often too short, and in many cases the laying time is exceeded. In these cases, adhesive must be reapplied. However, if this is not recognized, improper bonding is the result, which often is discovered only after some time has passed and then requires expensive restoration measures.

The object of the present invention is, therefore, to provide a solvent-based parquet adhesive that overcomes the above-mentioned disadvantages, in particular, the undesirable swelling of the parquet wood and the contamination of air at the workplace, and which therefore relies in particular on the use of aprotic polar solvents, such as volatile esters and ketones. A particular object of the invention is to prevent the evaporation of solvent in the workspace by implementing suitable measures before, during and after parquet coating, to the greatest extent possible, in order to ensure maximum parquet laying time as well as compliance with occupational exposure limit values.

The object of the invention was solved by a barrier layer that was generated immediately after the adhesive was applied to the surface and that largely prevented volatile solvents from escaping. The additives that are added for this purpose according to the invention create a solvent-impermeable film directly on the surface of the applied adhesive. These additives rapidly develop a contiguous film and are only minimally soluble in the polar solvents of the adhesive. Waxes and paraffins with a melting range of between 40 and 60° C. are particularly suitable as film-forming agents.

First, the film-forming agents are homogenously admixed with the adhesive, and partly dissolve. Immediately after the adhesive layer is applied to the floor, the solvent in the uppermost layer of the dispersed adhesive evaporates, which causes the film-forming agent dissolved in the adhesive to fall below its solubility limit, resulting in the precipitation of the film-forming agent in the boundary layer facing the air, thus forming the desired, continuous, solvent-impermeable film.

While the protective film is in contact with the surrounding air, the inherently volatile solvents are virtually completely retained within the layer to a surprising degree and are prevented from escaping into the surrounding airspace. During the subsequent processing steps, the formed protective film is destroyed by the laying of the parquet strips, allowing the solvent to escape slowly through the wood layer after the laying work is completed, thereby allowing the adhesive to cure rapidly, and thus making it possible to walk on the freshly laid floor only a few hours after completion of the laying work, without dislocating the parquet strips. Furthermore, if standard ventilation is provided, limit values for the respective solvents are not exceeded even during the subsequent drying phase. This ensures that the health of the individual involved in the laying work is protected against the hazards posed by the solvents according to the invention at any time during the parquet laying. Moreover, the effect achieved in this manner, i.e. the retention of the solvents in contact with air, permits significantly extended laying times. Compared to state-of-the-art adhesives with laying times of 10-20 minutes, laying times of several hours can be realized by the present invention. This allows the floor layer to pick a convenient time when to carry out the bonding process at any time within the extended laying time period. At the time that the adhesive force of the adhesive is required, the protective film is selectively destroyed by the parquet strip laying process.

From DE-A 103 36 360 it is already known that paraffins or waxes are added to free radical polymerizable reactive acrylate- and/or methacrylate-based resins, which are for example used as rapidly curing coating materials for floors, in order to generate for example an impermeable layer against oxygen on the floor after the resin has been applied, so problems associated with “oxygen inhibition” can be prevented, which causes sticky, even partially liquefied surfaces that are particularly unacceptable for floor coverings. The insufficient surface polymerization observed in the presence of oxygen is due to the interference of molecular oxygen with the radical-mediated polymerization mechanism, and is not limited to the immediate surface but also extends into the underlying deeper layers. By coating the surface with waxes or paraffins and thus abolishing oxygen permeability, polymerization of the monomeric acrylates can now occur without interference by oxygen radicals. To prevent exhalation of volatile synthetic components at the workplace, polymerization components were chosen such that short-chained, low-boiling acrylate components posing a potential odor nuisance risk were avoided in favor of components with a boiling point of more than 120° C., which, due to their low volatility, do not pose any odor nuisance risk. This “detour” had to be taken at the time, since the barrier effect of lipophilic surface layers on low-boiling and thus highly volatile organic components had not yet been recognized.

As previously mentioned, the conditions that apply to parquet adhesives are entirely different than those that apply to acrylate-based bonding agents. The preferably aprotic polar solvents to be used here, such as low molecular esters and ketones, all produce strong odors and have a boiling point well below 120° C. If the above-mentioned advantages of these components are to be utilized, it must be ensured that the escape of volatile solvent is minimized from the time the adhesive is applied to the floor to the time when the parquet is laid onto the applied adhesive layer.

Surprisingly it has now been shown that when only very small amounts of paraffin or wax are added according to the invention to the adhesive to be applied, the partially dissolved barrier material, such as wax, immediately “floats” to the surface of the applied thin layer and forms here an effective, contiguous and impermeable layer against solvent vapors, even though it would be expected that ketones and esters, being typical lipophilic substances, should generally behave differently towards the equally lipophilic wax or paraffins layer than molecular oxygen.

For this reason, it could not be expected even from an expert to foresee that lipophilic layers, of all things, would be suitable as an extremely effective barrier layer against lipophilic solvents. The unexpected nature of the effect is also underlined by the fact that in the case of DE-A103 36 360, it would have not been necessary to switch to less volatile, odorless monomers, if it had been realized that the oxygen barrier could also effectively prevent low-molecular, volatile organic compounds from penetrating the barrier layer. It also could not have been anticipated that the desired effect is already produced by the mere addition of only 0.05% w/w paraffin (preferably 0.2 to 3% w/w). However, increased amounts of paraffin can also be used, as long as this does not affect the strength of the dried adhesive. Pursuant to DE-A 103 36 360, in order to create a barrier layer against atmospheric oxygen, it can also be beneficial to add as component C an air-dried, unsaturated organic compound, such as butadiene, for strengthening the barrier layer. In the present invention this step is obsolete.

Creating a barrier layer according to the invention against problematic solvent vapors not only simplifies parquet coating significantly, but also ensures that each phase of the laying work complies with the required occupational exposure limit values.

General Description of Adhesive Composition in Percent by Weight:

Component A (solvent) 15-25%

Component B (thermoplastic polymer) 5-14%

Component C (resins) 5-25%

Component D (fillers) 30-60%

Component E (film-forming components) 0.05-2%

Component F additional additives up to 100%

Component A:

Solvents generally considered are aliphatic or cycloaliphatic hydrocarbons (e.g. hexane, heptanes, octane, methylcyclohexane), esters (e.g. methyl acetate, ethyl acetate, methoxypropylacetate, butyl acetate), aliphatic alcohols (e.g. ethanol, isopropanol), aliphatic ketones (e.g. acetone, methyl ethyl ketone, methylisobutyl ketone).

Component B:

Polyvinyl acetate and/or similar polymers

Component C:

Resins being considered are natural resins (e.g. gum rosins, colophonic rosins, tall rosins), gum rosin esters (e.g. glycerin ester, pentaerythriol esters), synthetic phenyl-modified and phenol-unmodified hydrocarbon resins. Preferred are synthetic hydrocarbon resins, with copolymers from petroleum-derived C9 hydrocarbons and phenol being particularly preferred.

Component D:

Fillers generally considered are inorganic fillers, such as calcium carbonate, calcium sulfate, barium sulfate, silicates, etc. Preferably used are natural, uncoated chalks.

Component E:

As film-forming components all substances are considered that have low solubility in the resin-polymer solvent mixture, thus allowing the formation of a solvent-impermeable surface layer through solvent evaporation after application of the film. Since the polymers and solvents are lipophilic substances, non-polar waxes and paraffins are particularly suitable for this purpose. Suitable substances, among others, are paraffins, microcrystalline waxes, carnauba wax, beeswax, lanolin, whale oil, polyolefin waxes, ceresin, candelilla waxes and alike. However, paraffins with a melting range between 40 and 60° C. have been found to be particularly suitable.

Component F:

As additional components, additives such as softeners, e.g. phthalic acid esters, e.g. diisobutylpthalate or diisononylphthalate, defoamers e.g. silicone defoamers, rheology additives e.g. bentones and/or dispersing agents e.g. acrylate polymers with acid or basic groups, are used.

The following examples only serve to explain the invention and are not intended to limit the invention in any way:

### EXAMPLE 1

### Comparative Example

An adhesive is manufactured, using the following components.

All percentages refer to the weight of components (% w/w):

6.5% acetone

11.5% methyl acetate

15.5% phenol-modified hydrocarbon resin (Novares® TNA 80, Ruttgers company)

4.0% polyvinyl acetate, mean molecular weight approximately 245,000 g/mol (Mowilith® 60, Harco)

7.0% polyvinyl acetate, mean molecular weight approximately 85,000 g/mol (Mowilith® 30, Harco)

55.5% calcium carbonate filler Mikrosöhl® Chalk 40

FC content: 82%

The viscosity of the adhesive according to Brookfield 6/10 at 23° C. was approximately 70,000 mPas.

### EXAMPLE 2

An adhesive is manufactured, using the following components.

All percentages refer to the weight of components (% w/w):

6.5% acetone

11.5% methyl acetate

15.5% phenol-modified hydrocarbon resin (Novares® TNA 80, Ruttgers company)

4.0% polyvinyl acetate, mean molecular weight approximately 245,000 g/mol (Mowilith® 60, Harco)

7.0% polyvinyl acetate, mean molecular weight approximately 85,000 g/mol (Mowilith® 30, Harco)

55% calcium carbonate filler Mikrosöhl® Chalk 40

0.5% paraffin wax, melting point 42-44° C., Merck Co.

FC content: 82%

Viscosity according to Brookfield (see example 1): 6/10 23° C.: approximately 70,000 mPas

Using an adhesive spreader B 11, approximately 180 g adhesive are applied on a chip board V 100 (30×60 cm). Directly after the application of the adhesive, the chip board is placed onto a laboratory scale with an accuracy to two decimal places, and the weight loss is determined at one minute intervals over a period of 20 minutes. The weight loss is directly proportional to the quantity of solvent emission (FIG. 1).

[image]

While adhesive 1 emits approximately 4% solvent during the laying time (20 minutes), adhesive 2 virtually completely retains the solvents through the use of paraffin according to the invention, and only minor loss (0.4%) is observed after 20 minutes. The solvent emissions that occur during processing are thus reduced by a factor of about 10. Measurements of workplace air values have shown that the airborne threshold limit values during parquet laying are clearly below the permissible limits, even under adverse conditions (windows closed, low air exchange). To obtain the data, a ORSA passive sampler was used to measure exposure levels at the workplace over a 2-hour period in which adhesives 1 and 2 were processed. The VOCs collected during the processing were then quantitatively analyzed. The following values were obtained:

| | Example 1 | Example 2 | OEL |
|---|---|---|---|
| Acetone | 429 mg/m³ | 117 mg/m³ | 1200 mg/m³ |
| Methyl acetate | 583 mg/m³ | 209 mg/m³ | 600 mg/m³ |
| Cumulative factor | 1.31 | 0.44 | <1 |
| evaluation | | | |

In order to evaluate the occupational exposure limit values of multi-component solvent systems, the ratio between the respective individual value and its limit value is formed, and the obtained ratio values are added. The sum must be <1 in order to be in overall compliance with occupational exposure limit values. As the results of the workplace measurements illustrate, the limit value of the comparative example was at 1.31 clearly above the limit and in the case of example 2 at 0.44 significantly below the limit.

Determination of the Maximum Laying Time:

Using an adhesive spreader B 11, approximately 180 g adhesive is applied on a chip board V 100 (30×60 cm). At 5-minute intervals, oak parquet strips (160 mm×30×mm 8 mm) are placed into the adhesive bed, briefly pressed down, picked up again and then evaluated for adhesive wetting on the back of the wooden strip. As shown in the following table, the maximum laying time for the state-of-the-art adhesive is exceeded after 10-20 minutes, whereas the maximum laying time for invention-accordant adhesive 2 is not reached even after 2 hours have passed.

| | Example 1 | Example 2 |
|---|---|---|
| Time [min] | Wetting on the back | Wetting on the back |
| 5 | 95% | 95% |
| 10 | 90% | 95% |
| 15 | 80% | 95% |
| 20 | 60% | 95% |
| 25 | 33% | 95% |
| 30 | 10% | 95% |
| 35 | 0% | 95% |
| 40 | 0% | 95% |
| 45 | 0% | 95% |
| 50 | 0% | 95% |
| 55 | 0% | 95% |
| 60 | 0% | 95% |
| 65 | 0% | 95% |
| 70 | 0% | 95% |
| 75 | 0% | 95% |
| 80 | 0% | 95% |
| 85 | 0% | 95% |
| 90 | 0% | 95% |
| 95 | 0% | 95% |
| 100 | 0% | 95% |
| 105 | 0% | 95% |
| 110 | 0% | 95% |
| 115 | 0% | 95% |
| 120 | 0% | 95% |

Determination of Strength Development:

To determine strength development, bonded joints pursuant to DIN Standard 281 are prepared. Tensile shear strengths are determined after 1, 3 and 28 days according to DIN 281. The following values were found:

| | Example 1 | Example 2 |
|---|---|---|
| Days | N/mm² | N/mm² |
| 1 | 1.7 | 1.5 |
| 3 | 3.7 | 3.5 |
| 28* | 4.8 | 4.5 |

*Temperature change cycle: 1 d: 23° C., 21 d: 40° C., 6 d: 23° C.

As the values indicate, the invention-accordant formulation of Example 2 meets DIN 281 requirements for shear-resistant parquet adhesives.

The solvent retaining properties of waxes and/or paraffins also apply to other solvent mixtures, e.g. ternary mixtures from acetone, methyl acetate and ethanol, and in higher solvent concentrations of, for example, up to 25%. Adhesives with higher solvent content can be formulated with higher molecular weight polymers, which results in the faster buildup of higher strength values, thus providing additional safety with respect to deformation stability for particular types of parquet and wood. This is proven by the following application examples:

### EXAMPLE 3

### Comparative Example

An adhesive is manufactured, using the following components.

All percentages refer to the weight of components (% w/w):

4.0% acetone

14.0% ethanol

16.5% phenol-modified hydrocarbon resin (Novares® TNA 80, Ruttgers company)

7.0% polyvinyl acetate, mean molecular weight approximately 245,000 g/mol (Mowilith® 60, Harco)

3.0% polyvinyl acetate, mean molecular weight approximately 85,000 g/mol (Mowilith® 30, Harco)

55.5% calcium carbonate filler Mikrosohl® Chalk 40

FC content: 82%

Brookfield viscosity (see Example 1) 6/10 23° C.: approximately 90,000 mPas

### EXAMPLE 4

An adhesive is manufactured, using the following components.

All percentages refer to the component weight (% w/w):

4.0% acetone

14.0% ethanol

16.5% phenol-modified hydrocarbon resin (Novares® TNA 80, Rüttgers company)

7.0% polyvinyl acetate, mean molecular weight approximately 245,000 g/mol (Mowilith® 60, Harco)

3.0% polyvinyl acetate, mean molecular weight approximately 85,000 g/mol (Mowilith® 30, Harco)

55% calcium carbonate filler Mikrosohl® Chalk 40

0.5% paraffin wax, melting point 42-44° C., Merck Co.

FC content: 82%

Brookfield viscosity (see Example 1) 6/10 23° C.: approximately 90,000 mPas

### EXAMPLE 5

An adhesive is manufactured, using the following components.

All percentages refer to the component weight (% w/w):

8.0% acetone

6.0% methyl acetate

8.5% ethanol

9.0% phenol-modified hydrocarbon resin (Novares® TNA 80, Ruttgers company)

7.0% polyvinyl acetate, mean molecular weight approximately 245,000 g/mol (Mowilith® 60, Harco)

6.0% polyvinyl acetate, mean molecular weight approximately 85,000 g/mol (Mowilith® 30, Harco)

55.0% calcium carbonate filler Mikrosohl® Chalk 40

FC content: 77.5%

Brookfield viscosity 6/10 23° C.: approximately 30,000 mPas

### EXAMPLE 6

An adhesive is manufactured, using the following components.

All percentages refer to the component weight (% w/w):

8.0% acetone

6.0% methyl acetate

8.5% ethanol

9.0% phenol-modified hydrocarbon resin (Novares® TNA 80, Ruttgers company)

7.0% polyvinyl acetate, mean molecular weight approximately 245,000 g/mol (Mowilith® 60, Harco)

6.0% polyvinyl acetate, mean molecular weight approximately 85,000 g/mol (Mowilith® 30, Harco)

54.5% calcium carbonate filler Mikrosohl® Chalk 40

0.5% paraffin wax, melting point 42-44° C., Merck Co.

FC content: 77.5%

Brookfield viscosity (see Example 1) 6/10 23° C.: approximately 30,000 mPas

Using an adhesive spreader B 11, approximately 180 g adhesive is applied on a chip board V 100 (30×60 cm). Directly after application of the adhesive, the chip board is placed onto a laboratory scale with an accuracy to two decimal places, and the weight loss is determined at one minute intervals over a period of 20 minutes. The weight loss is directly proportional to the quantity of solvent emission (FIG. 3).

[image]

[image]

In these application examples, too, paraffin-modified formulations show significantly improved evaporation characteristics relative to state-of-the-art adhesives. The solvent emissions that occur during processing are here also reduced by a factor of about 10. Measurements of workplace air values have shown that the airborne threshold limit values during parquet laying are clearly below the permissible limits, even under adverse conditions (windows closed, low air exchange).

Determination of Maximum Laying Time:

Using an adhesive spreader B 11, approximately 180 g adhesive is applied on a chip board V 100 (30×60 cm). At 5 minute intervals, oak parquet strips (160 mm×30 mm 8 mm) are placed into the adhesive bed, briefly pressed down, picked up again, and then evaluated for adhesive wetting on the back of the wooden strip. As shown in the following table, the maximum laying time for the state-of-the-art adhesives 3 and 5 is exceeded after 10-20 minutes, whereas the maximum laying time for invention-accordant adhesive 4 and 6 has not been reached even after 2 hours have passed.

| | Example 3 | Example 4 | Example 5 | Example 6 |
|---|---|---|---|---|
| Time | Wetting on the | Wetting on the | Wetting on | Wetting on |
| [min] | back | back | the back | the back |
| 5 | 95% | 95% | 95% | 95% |
| 10 | 90% | 95% | 95% | 95% |
| 15 | 85% | 95% | 90% | 95% |
| 20 | 70% | 95% | 80% | 95% |
| 25 | 40% | 95% | 60% | 95% |
| 30 | 20% | 95% | 40% | 95% |
| 35 | 10% | 95% | 10% | 95% |
| 40 | 0% | 95% | 0% | 95% |
| 45 | 0% | 95% | 0% | 95% |
| 50 | 0% | 95% | 0% | 95% |
| 55 | 0% | 95% | 0% | 95% |
| 60 | 0% | 95% | 0% | 95% |
| 65 | 0% | 95% | 0% | 95% |
| 70 | 0% | 95% | 0% | 95% |
| 75 | 0% | 95% | 0% | 95% |
| 80 | 0% | 95% | 0% | 95% |
| 85 | 0% | 95% | 0% | 95% |
| 90 | 0% | 95% | 0% | 95% |
| 95 | 0% | 95% | 0% | 95% |
| 100 | 0% | 95% | 0% | 95% |
| 105 | 0% | 95% | 0% | 95% |
| 110 | 0% | 95% | 0% | 95% |
| 115 | 0% | 95% | 0% | 95% |
| 120 | 0% | 95% | 0% | 95% |

Determination of Strength Development:

In order to determine strength development, bonded joints pursuant to DIN Standard 281 are prepared. Tensile shear strengths are determined after 1, 3 and 28 days according to DIN 281. The following values were found:

| | Example 3 | Example 4 | Example 5 | Example 6 |
|---|---|---|---|---|
| Days | N/mm² | N/mm² | N/mm² | N/mm² |
| 1 | 1.5 | 1.4 | 4 | 3.4 |
| 3 | 3.5 | 3.3 | 5.9 | 4.9 |
| 28* | 3.9 | 4 | 6 | 5.6 |

*Temperature change cycle: 1 d: 23° C., 21 d: 40° C., 6 d: 23° C.

As the values indicate, the invention-accordant formulations of examples 4 and 6 meet the DIN 281 requirements for shear-resistant parquet adhesives.

The use of paraffin can of course also be employed in solvent-based adhesive systems for other flooring, such as carpeting. These adhesive systems, similar to parquet adhesives, consist of solvents, polymeric bonding agents and adhesive-promoting resins. The following examples are intended to demonstrate that the barrier effect of the paraffins basically also works in these systems:

### EXAMPLE 7

### Comparative Example

6% acetone

4% ethanol

3% specialty gasoline, boiling point 60-95° C.

17% gum rosin

5% glycerin ester gum

5% polyvinyl diethyl ether (Lutanol A 50, BASF)

60% micros oil 40 (chalk; filler)

FC content: 855%

Brookfield viscosity 6/10 23° C.: approximately 40,000 mPas

### EXAMPLE 8

6% acetone

4% ethanol

3% specialty gasoline, boiling point 60-95° C.

17% gum rosin

5% glycerin ester gum

5% polyvinyl diethyl ether (Lutanol A 50, BASF)

59.3% micros oil 40 (chalk; filler)

0.7% paraffin wax, melting point 42-44° C., Merck Co.

FC content: 85.5%

Brookfield viscosity 6/10 23° C.: approximately 40,000 mPas

Using an adhesive spreader B 1, approximately 100 g adhesive are applied on a chip board V 100 (30×60 cm). Directly after application of the adhesive, the chip board is placed onto a laboratory scale with an accuracy to two decimal places, and the weight loss is determined at five minute intervals over a period of 15 minutes. The weight loss is directly proportional to the quantity of solvent emission.

| | Example 7 | Example 8 |
|---|---|---|
| Solvent loss | 1.2% | 0.25% |
| after 5 min. | | |
| Solvent loss | 2.3% | 0.25% |
| after 10 min. | | |
| Solvent loss | 3.7% | 0.25% |
| after 15 min. | | |

As these examples demonstrate, the solvent emission of the comparative example adhesive system 7 is approximately 3.7% within a laying period of 15 minutes, whereas the adhesive system in example 8 emits only 0.25%.

1. Process for preventing or reducing organic solvent emissions into the surrounding air from liquid, shear-resistant parquet adhesives with a shear resistance over two Newton/mm², during and after the laying of the flooring or the parquet strips, wherein, before application, at least one substance is added to the adhesive containing the solvent made up of organic solvents, soluble bonding agent components and inorganic fillers and/or additives, where said substance develops a barrier layer to prevent the penetration of the volatile solvents into the surrounding air after the adhesive has been applied to the surface.

2. Process according to claim 1, wherein the substances forming the barrier layer are paraffins or waxy substances, which are only partially soluble in the solvent mixture used.

3. Process according to claim 1, wherein 0.05 to 5% by weight of paraffins or waxy substances are added to the adhesive.

4. Process according to claim 1, wherein the bonding agent portion consists of at least one resin and/or one polymer component.

5. Process according to claim 1, wherein natural resins and/or synthetic resins are used as the resin component.

6. Process according to claim 5, wherein the synthetic resins are derived from the hydroxyl-modified coumarone-indene resin family or phenol-modified hydrocarbon resin family.

7. Process according to claim 1, wherein polymers from the group of vinyl esters, vinyl ethers, acrylic acid esters, methacrylic acid esters, styrenes, butadiens, isoprenes or its copolymers are used as the polymer component.

8. Process according to claim 1, wherein calcium carbonate, calcium sulfate, barium sulfate, silicates or mixtures of these substances are used as the filler and inorganic additive.

9. Process according to claim 1, wherein aliphatic hydrocarbons, cycloaliphatic hydrocarbons, esters, aliphatic alcohols, aliphatic ketones or mixtures of these are used as solvent.

10. Parquet adhesive according to claim 1 with a content of between 0.05 and 5% by weight of a film-forming component, comprising paraffins, microcrystalline waxes, carnauba wax, beeswax, lanolin, whale oil, polyolefin waxes, ceresin, candelilla wax, and related waxy substances.

11. Use of paraffins, microcrystalline waxes, carnauba wax, beeswax, lanolin, whale oil, polyolefin waxes, ceresin, candelilla wax and related waxy substances as film-forming substances to prevent the permeability of organic solvents with a boiling point below 100° C. in flooring and parquet adhesives.

12. Use according to claim 11, in which the film-forming substances are used in a quantity of 0.05 to 5% by weight based on the sum of the remaining components of the adhesive.

13. Process according to claim 2, wherein 0.05 to 5% by weight of paraffins or waxy substances are added to the adhesive.

14. Process according to claim 2, wherein the bonding agent portion consists of at least one resin and/or one polymer component.

15. Process according to claim 3, wherein the bonding agent portion consists of at least one resin and/or one polymer component.

16. Process according to claim 13, wherein the bonding agent portion consists of at least one resin and/or one polymer component.

17. Process according to claim 2, wherein natural resins and/or synthetic resins are used as the resin component.

18. Process according to claim 3, wherein natural resins and/or synthetic resins are used as the resin component.

19. Process according to claim 4, wherein natural resins and/or synthetic resins are used as the resin component.

20. Process according to claim 13, wherein natural resins and/or synthetic resins are used as the resin component.
